(19) United States
(12) Patent Application Publication
(10) Pub. No.: US 2026/0218503 A1
(43) Pub. Date: Jul. 30, 2026

(54) Connection Assembly for Connecting Together Two Pipe Sections

(71) Applicant: GENI*US BVBA, Sint-Truiden (BE)

(72) Inventor: Geert Rita Erik Victor Nivelles, Sint-Truiden (BE)

(21) Appl. No.: 19/145,596

(22) PCT Filed: Jan. 4, 2024
(86) PCT No.: PCT/EP2024/000001

§ 371 Date: Jul. 3, 2025

(30) Foreign Application Priority Data
Jan. 6, 2023 (NL) 1044517

(51) Int. Cl. E03F 5/04; F16L 27/107

(52) U.S. Cl. CPC E03F 5/0408; F16L 27/107; E03F 2005/0413

(57) ABSTRACT

A connection assembly includes a connection sleeve having an input skirt portion, and a tightening assembly arranged inside the connection sleeve. The tightening assembly includes a displaceable clamp carrier around which an annular clamp is carried in a tense condition, and a stationary clamp shifter arranged around the clamp carrier for shifting the annular clamp off the clamp carrier to clamp around the input skirt portion.

### CROSS-REFERENCE TO RELATED APPLICATIONS

This application is the United States national phase of International Patent Application No. PCT/EP2024/000001 filed Jan. 4, 2024, and claims priority to The Netherlands Patent Application No. 1044517 filed Jan. 6, 2023, the disclosures of which are hereby incorporated by reference in their entireties.

### BACKGROUND OF THE INVENTION

### Field of the Invention

The present invention relates in general to the field of connecting pipes such that the connected pipes form a continuous flow path for a gas or a liquid.

The present invention is particularly useful in the field of sanitary systems, and the following explanation is based on sanitary systems in general, and a shower drain in particular.

### Description of Related Art

The drainage for showers, baths and similar sanitary systems is normally arranged in the floor. That may be a wooden floor, with the drainage arranged between the floor and the ceiling of the room(s) below. That may also be a concrete floor, with the drainage arranged in the concrete. The drainage will comprise a drainage pipe with an entrance section. Typically, this entrance will be directed vertically upward, and its position will be fixed with respect to the floor, for instance by the concrete of that floor.

When a shower cabin or shower floor panel or similar is to be installed, it is possible that such is installed at a raised level, with its floor higher than the drainage pipe's entrance and horizontally offset from the drainage pipe's entrance, so that the drainage pipe's entrance is located outside the footprint of the shower floor. In such case, connecting to the drainage pipe's entrance is relatively easy because the drainage pipe's entrance is accessible for a worker.

But in many cases, for the purpose of design and comfort, the shower floor is to be installed at floor level and the drainage pipe's entrance is located under the shower floor, not accessible anymore when the shower floor has been placed. A particular situation in practice is the case of a walk-in shower. Then, connecting to the drainage pipe's entrance is difficult.

The shower space will have a shower drain arranged in its floor, which may for instance have an elongate gutter-like shape, and which comprises a drain exit opening surrounded by a drain exit pipe section, indicated hereinafter as discharge pipe section.

Traditional solutions involve a drain with a vertical discharge pipe section, which is inserted vertically into the drainage pipe's entrance, with an annular seal in the drainage pipe's entrance section providing sealing between the discharge pipe section and the drainage pipe's entrance section, the annular seal typically being a rubber ring. As simple as this seems, it is actually difficult to ensure a good sealing in various practical circumstances, including misalignment of the pipe sections.

In international patent application WO 2021/053466, the present applicant has proposed a solution with a rubber sleeve to be attached to the drainage pipe's entrance section. At its upper end, the sleeve has an inward folded edge portion with an inverted U-shaped slot defined between said edge portion and an outer wall of the sleeve. An annular clamp is inserted into said slot. The annular clamp has a relaxed condition with a relatively small diameter, smaller than the outer diameter of said folded edge portion, and an open condition with a larger diameter, wider than the outer diameter of said folded edge portion. The annular clamp is arranged in the U-shaped slot in its open condition, the shower drain is placed with its discharge pipe section introduced into the sleeve, and the annular clamp is allowed to relax so that it clamps the sleeve's folded edge portion onto the outer surface of the discharge pipe section with high force, to thus ensure good sealing. For bringing the annular clamp from its open condition to its relaxed condition, a tool is used that extends through the discharge pipe section up to a user above the shower floor, in any case above the drain.

Although the solutions described in WO 2021/053466 function well, the invention aims to offer further improvements. The fact that the clamp is to be manipulated with a tool that reaches through the narrow pipe section is a difficulty. The clamp should preferably be a strong clamp, so that high friction forces are exerted on the tool that keeps the clamp open and/or that relaxes the clamp. While manipulating the tool, it has to be ensured that the clamp stays in the correct position. Reaction forces caused by the manipulating act on the sleeve and may cause the sleeve to become displaced.

### SUMMARY OF THE INVENTION

An object of the present invention is to overcome at least one, preferably all, of the above difficulties.

A connection assembly for connecting together two pipe sections disposed opposite each other has a connection sleeve with an input skirt portion and a tightening assembly arranged inside the connection sleeve. The tightening assembly has a clamp carrier around which an annular clamp is carried in a tense condition. A clamp shifter is arranged around the clamp carrier for shifting the annular clamp off the clamp carrier to clamp around the input skirt portion.

The connection assembly may have an outer mantle, and output portion, an input portion and a skirt, with a bridge connecting the skirt to the outer mantle. The skirt has a free and directed away from the bridge to the output portion with an annular accommodation slot defined between the skirt the outer mantle and the bridge. A tightening assembly is arranged inside the connection sleeve. Manipulation means are adapted to be manipulated by a tool that extends through the skirt thereby releasing the annular clamp. The manipulation means includes a clamp carrier and a clamp shifter.

### BRIEF DESCRIPTION OF THE DRAWINGS

The terms Fig., Figs., Figure, and Figures are used interchangeably in the specification to refer to the corresponding figures in the drawings.

These and other aspects, features and advantages of the present invention will be further explained by the following description of one or more preferred embodiments with reference to the drawings, in which same reference numerals indicate same or similar parts, and in which:

FIG. 1 schematically shows an example of a sanitary installation with an exemplary embodiment of a connection assembly according to the present invention, with the annular clamp being positioned on the clamp carrier;

FIG. 2 is an illustration comparable to FIG. 1, with the annular clamp being positioned on the skirt of the connection sleeve;

FIG. 3 illustrates further possible details of a connection assembly according to the present invention.

### DESCRIPTION OF THE INVENTION

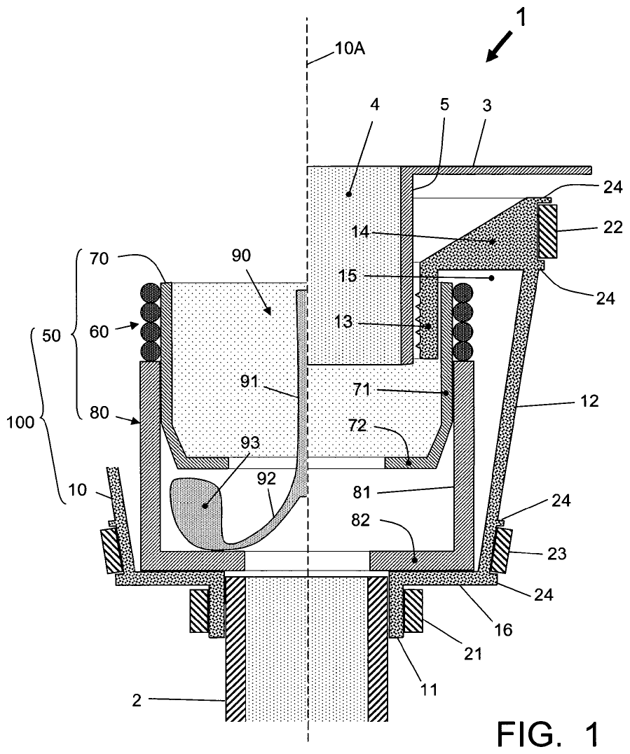

FIG. 1 schematically illustrates an example of an embodiment of the present invention.

Reference numeral 2 indicates an entrance portion of a drainage pipe, having a longitudinal axis directed vertically.

Reference numeral 3 indicates a portion of a bottom plate of a sanitary installation 1, which may for instance be a shower floor or a drain channel or the like. The bottom plate 3 has a discharge opening 4, and at its lower side the bottom plate 3 is provided with a discharge pipe section 5 surrounding the discharge opening 4.

Reference numeral 100 indicates a connection assembly.

The connection assembly 100 comprises a connection sleeve 10 for sealingly connecting the discharge pipe section 5 to the drainage pipe entrance portion 2. It is to be noted that, once the sanitary installation 1 is placed in its intended position, the drainage pipe entrance portion 2 and the connection sleeve 10 are no longer accessible from outside, i.e. from above.

The connection sleeve 10, and in fact the entire connection assembly 100, generally may have rotational symmetry with respect to a central axis 10A, which in the figure is shown vertically and aligned with the axis of the drainage pipe entrance portion 2.

At its lower end, the connection sleeve 10 has a substantially cylindrical output portion 11, that fits snugly around the drainage pipe entrance portion 2. The output portion 11 is attached and sealed to the drainage pipe entrance portion 2. Attachment and sealing means may include a glue or similar, which is particularly suitable if the output portion 11 is made of PVC or similar. In the example shown, attachment and sealing means may include an annular clamp 21 that can be tightened by manipulating a screw (not shown for sake of simplicity). Such clamps are known per se and a more detailed explanation of the details of this clamp is omitted here. For cooperation with such clamp, the output portion 11 may be made from a compressible material like rubber, and in fact the entire connection sleeve 10 may be made as one-piece from a rubber.

It is to be noted that the connection sleeve 10 is attached to the drainage pipe entrance portion 2 before the floor is finished, so that the annular clamp 21 is accessible for tightening. After attaching the connection sleeve 10 to the drainage pipe entrance portion 2, the floor is finished, for instance by placing floor boards, leaving an opening for the connection assembly 100. The connection assembly 100 may be fastened to the floor, as will be described later.

Above the output portion 11, the connection sleeve 10 has an annular bottom portion 16 connecting to an outer mantle 12, preferably and as shown extending substantially radially.

At its upper end, the outer mantle 12 has an internal skirt 13, for instance in the form of an inward folding of the outer mantle's upper edge, although it may be that the outer mantle 12 extends higher than the internal skirt 13. The material portion 14 connecting the skirt 13 to the outer mantle 12 is indicated as bridge 14. It is noted that the skirt 13 has smaller diameter than the outer mantle 12, and has a free end directed away from the bridge 14 towards the output portion 11, i.e. downwards in the figure. The skirt 13 serves to connect to discharge pipe section 5 and can be considered to constitute an input portion of the connection sleeve 10. For improved sealing, the skirt 13 may be provided with annular ridges protruding inward.

Between them, the skirt 13, the outer mantle 12 and the bridge 14 have an inverted U-shaped contour defining an annular accommodation slot 15 for an annular clamp, as will be described in more detail. The upper surface of the bridge 14 may be slanted to facilitate the introduction of the discharge pipe section 5.

The contour of the skirt 13 conforms to the contour of the discharge pipe section 5, which typically will be substantially cylindrical with a circular or oval cross-sectional contour.

The connection assembly 100 further comprises a tightening assembly 50 arranged inside the connection sleeve 10.

The tightening assembly 50 was introduced into the connection sleeve 10 in a preparation step, which included radially stretching the output portion 11 of the connection sleeve 10 and introducing the tightening assembly 50 through the widened output portion 11. A tool advantageous for use in this preparation step may comprise an annular frame carrying a plurality of stretch fingers directed inward, capable of engaging the output portion 11 and exerting radial pulling force thereon.

The tightening assembly 50 comprises an elastic annular clamp 60, a clamp carrier 70, and a clamp shifter 80.

The clamp carrier 70 has a carrier body 71 with a substantially cylindrical appearance, with an inner diameter corresponding to, and preferably slightly larger than, the outer diameter of the skirt 13. At the lower end of the carrier body 71, the clamp carrier 70 has an inward flange 72, which may be formed as an annular contiguous ridge or a series of spaced ridge portions. The inward flange 72 has an inner diameter smaller than the inner diameter of the discharge pipe section 5 for which the connection sleeve 10 is intended.

The clamp carrier 70 may be made of metal, for instance stainless steel, aluminium, copper, but it may also be made of a plastic material, for instance PE, PP, PVC.

The same applies to the clamp shifter 80.

The annular clamp 60, having a cross-sectional contour fitting to the cross-sectional contour of the skirt 13, has a relaxed condition in which it has an inner diameter smaller than the outer diameter of the skirt 13. The annular clamp 60 can be radially expanded to a stressed condition; in this condition, the annular clamp 60 exerts a clamping force directed radially inward, and when the annular clamp 60 is released, it relaxes to assume its relaxed condition while reducing its diameter. In an exemplary embodiment, as shown, the annular clamp 60 is implemented as a helix spring.

In a preparation step, the annular clamp 60 is expanded and applied around an upper portion of the carrier body 71 of the clamp carrier 70. The annular clamp 60 then partially relaxes so that it clamps tightly on the outer surface of the carrier body 71.

The tightening assembly 50 fits tightly inside the connection sleeve 10. The clamp carrier 70 has the upper portion of its carrier body 71 extending around the skirt 13, with its upper end in close proximity to the bridge 14. The carrier body's upper end preferably contacts the bridge 14. This ensures that the annular clamp 60 is at an axial position around the skirt 13.

The clamp shifter 80 has a shifter body 81 with a substantially cylindrical appearance. At the lower end of the shifter body 81, the clamp shifter 80 has an inward flange 82, which may be formed as an annular contiguous ridge or a series of spaced ridge portions.

The shifter body 81 has an inner diameter corresponding to, but larger than, the outer diameter of the carrier body 71, and smaller than the outer diameter of the carrier body 71 plus two times the radial thickness of the annular clamp 60. Preferably, the inner diameter of the shifter body 81 is smaller than the outer diameter of the carrier body 71 plus one time the radial thickness of the annular clamp 60.

The outer diameter of the shifter body 81 may correspond to the outer diameter of the annular clamp 60 in its expanded condition around the clamp carrier 70.

The clamp carrier 70 is arranged inside the clamp shifter 80, with the shifter body 81 extending around the carrier body 71 up to the annular clamp 60. The inward flange 82 of the clamp shifter 80 is in close proximity of, and may rest on, the bottom portion 16 of the connection sleeve 10. The inward flange 82 of the clamp shifter 80 has an internal diameter smaller than the outer diameter of the drainage pipe's entrance section 2, to form a stop for the drainage pipe's entrance section 2 to avoid the drainage pipe's entrance section 2 from entering the interior of the connection sleeve 10. Alternatively or additionally, the output portion 11 may be provided with one or more internal protrusions, or an internal annular ridge, for obtaining the same effect.

The axial height of the shifter body 81 corresponds to the axial height of the clamp carrier 70, so that the shifter body 81 defines an accommodation space for the clamp carrier 70.

In a first step of installing a shower floor or similar in accordance with the present invention, first the connection sleeve 10 is connected to the drainage pipe entrance portion 2, as discussed above. Then, the shower floor or similar is put in place, with the discharge pipe section 5 introduced into the skirt 13 of the connection sleeve 10. The shower floor or similar can be manoeuvred in horizontal direction for perfect positioning with respect to the surrounding floor and/or wall: the connection sleeve 10 has sufficient flexibility to allow slight horizontal displacements. Also, the connection sleeve 10 is particularly useful in combination with shower drains having an adjustable discharge pipe.

Care is taken that the shower floor or similar is placed in exactly the right vertical position with respect to its surroundings: the skirt 13 allows for vertical adjustments.

FIG. 1 shows the connection assembly 100 after completion of this first step of installing. It can be seen that, in this first step, the tightening assembly 50 inside the connection sleeve 10 does not interfere.

A second step of installing involves displacing the clamp carrier 70 down while keeping the clamp shifter 80 in place. As a result, the annular clamp 60 is shifted axially off the clamp carrier 70. Better said, with respect to the skirt 13, the annular clamp 60 will be held in place by the clamp shifter 80 and the clamp carrier 70 will displace downward with respect to the stationary clamp shifter 80 and annular clamp 60.

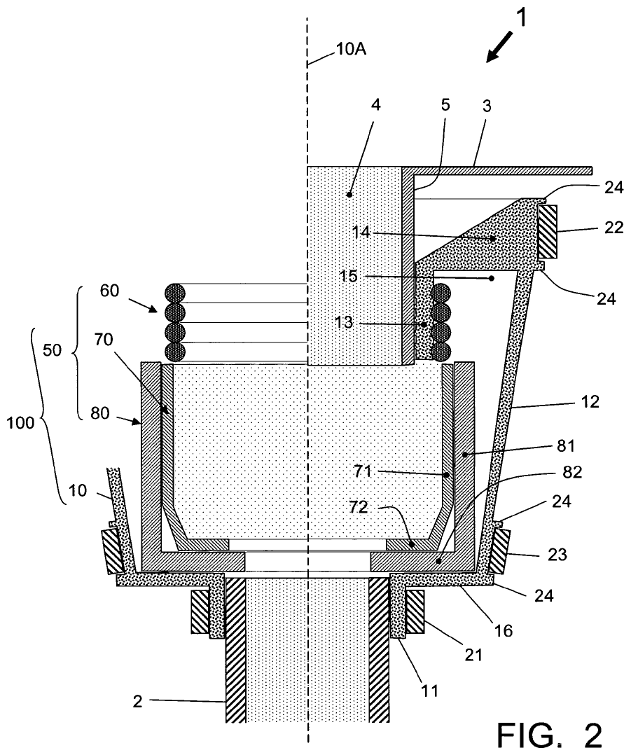

Once the annular clamp 60 is no longer supported by the clamp carrier 70, it will relax and tighten around the skirt 13; this situation is illustrated in FIG. 2. In the case of a clamp 60 implemented as a helix, the helix′ windings will gradually shift off the clamp carrier 70 and will gradually increase their tightening grip on the skirt 13.

In order to prevent the clamp carrier 70 being displaced down prematurely, the tightening assembly 50 may be provided with a stop device 90 (for sake of clarity only shown in the lefthand side of the drawing) comprising one or more stop members 93 arranged in the space between the flanges 72 and 82. In an exemplary embodiment, such stop device 90 may comprise an axial stem 91 having a free upper end, with a plurality of for instance three or more flexible arms 92 extending in a radial direction, or in a direction having a radial and an axial component, away from the lower end of the axial stem 91. At their free ends, the arms 92 have the respective stop members 93, of which the precise shape is not critical.

The stop device 90 can be removed by a person by engaging the free end of the axial stem 91 and pulling upwards. Engaging can be done between fingertips, or by using a tool such as a pair of pliers. It is also possible that the free end of the axial stem 91 is shaped as a hook, for allowing to be engaged by a hook-shaped tool.

When a user is installing the sanitary installation 1, and wishes to connect the connection assembly 100 to the discharge pipe section 5, he can do this by removing the stop device 90 and then moving clamp carrier 70 down with respect to the clamp shifter 80 such as to cause the clamp 60 to engage the skirt 13. For this purpose, he can apply a tool having a mechanism similar to a glue gun, with two hook-shaped member, one for engaging above flange 72 and the other engaging below flange 82. When the first hook is displaced axially down while the second hook is kept stationary to keep the clamp shifter 80 in place, the reaction forces on the clamp shifter 80 are accommodated in the tool itself.

It is however also possible to introduce into the discharge pipe section 5 a pushing tool, that may be implemented as a solid bar or hollow tube having a shape and size corresponding to the internal contour of the discharge pipe section 5. This tool is moved down until it meets the flange 72 of the clamp carrier 70. Then, the user exerts on the tool, which now engages the flange 72 of the clamp carrier 70, a strong force pushing down on the flange 72 of the clamp carrier 70. When the clamp carrier 70 has moved down sufficiently far to release the clamp 60, the user feels that the clamp carrier 70 is now loose, and he can pull up the said tool.

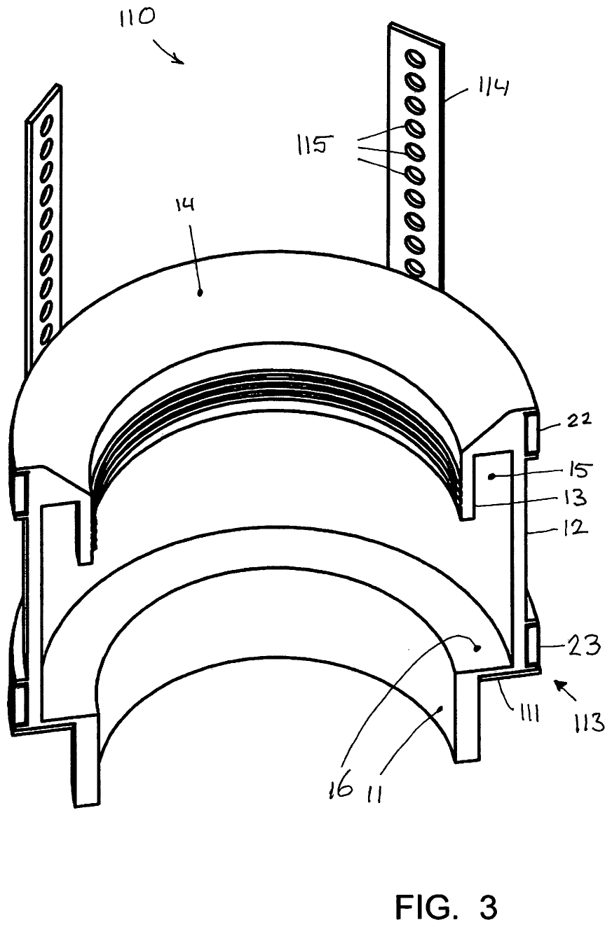

While the user is exerting the down force, the clamp 60 is pushing down on the clamp shifter 80. For making the clamp shifter 80 resist this down force such as to keep the clamp shifter 80 and hence the clamp 60 in place, the clamp shifter 80 may bear on the drainage pipe's entrance section 2, either directly or by the bottom portion 16 of the connection sleeve 10 being supported by the friction between the output portion 11 and the drainage pipe's entrance section 2. It is also possible that one does not wish to load the drainage pipe's entrance section 2, and for such situation one may provide the connection assembly 100 with an external shifter support 110, for accommodating this force and diverting this force towards the floor. FIG. 3 illustrates an example of such external shifter support 110.

The external shifter support 110 may comprise a support ring 111 arranged under the bottom portion 16 of the connection sleeve 10, and a plurality of support arms 112 having one end 113 attached to, or formed integrally with, the support ring 111. The number of support arms 112 is at least two or three, but may be four or five or even more, as desired. The support arms 112 are relatively thin strips, sufficiently strong for accommodating the expected forces, and bendable; for instance they are made of sheet metal.

The support arms 112 extend upwards from the support ring 111, along the outside of the connection sleeve mantle 12. Their axial length is greater than the axial size of the connection sleeve mantle 12, so that the support arms 112 have an upper portion 114 extending above the connection sleeve 10. Through holes 115 may be pre-arranged in said upper portion 114.

When the sanitary installation 1 is installed, the connection assembly 100 is attached to the discharge pipe section 5, as described before, after which the floor is placed, for instance wooden boards, leaving a passage through which the connection assembly 100 extends, or in any case the support arms 112 extend up through the passage. When the floor is in place, the respective portions of the support arms 112 extending above the floor are bent outwards to lie flat on the floor, and are attached to the floor. This attaching may for instance be done by screws passing through the holes 115. After this, the floor may be finished over the support arms 112 without being hindered by the presence of the thin support arms 112.

It may be desirable to design the connection assembly 100 such that it is capable of withstanding high internal pressures caused by gas or liquid without losing its sealing properties. For that purpose, a second annular clamp 22 may be arranged around an uppermost portion of the connection sleeve's mantle 12, aligned with the bridge 14, and a third annular clamp 23 may be arranged around a lowermost portion of the connection sleeve's mantle 12, just above the bottom portion 16. For axially securing these second annular clamp 22 and third annular clamp 23, the connection sleeve's mantle 12 may be provided with annular ridges 24.

It is also possible that a strong yet flexible metal jacket (not shown), for instance having an axial-wave-shaped cylindrical mantle, is arranged around the entire mantle 12, between the mantle 12 and said two annular clamps 22, 23.

It should be clear to a person skilled in the art that the present invention is not limited to the exemplary embodiments discussed above, but that several variations and modifications are possible within the protective scope of the invention as defined in the appending claims.

Even if certain features are recited in different dependent claims, the present invention also relates to an embodiment comprising these features in common.

Even if certain features have been described in combination with each other, in one embodiment having all these features, it is also possible that the present invention is put to practice in an embodiment that does not have all these features in common. The mere fact that such features have been described and illustrated by reference to a single device showing all these features together does not mean that all these features must always by applied together: features which have not been explicitly described as being essential may be omitted, as long as within the protective scope of the invention as defined in the appending claims.

Any reference signs in a claim should not be construed as limiting the scope of that claim.

1. A connection assembly for connecting together two pipe sections disposed opposite each other, the connection assembly comprising a connection sleeve having an input skirt portion, and a tightening assembly arranged inside the connection sleeve, wherein the tightening assembly comprises a clamp carrier around which an annular clamp is carried in a tense condition, and a clamp shifter arranged around the clamp carrier for shifting the annular clamp off the clamp carrier to clamp around the input skirt portion.

2. A connection assembly for connecting together two pipe sections disposed opposite each other according to claim 1, the connection assembly comprising:
a connection sleeve having:
an outer mantle;
an output portion arranged at a first end of the outer mantle, adapted for being applied around a first pipe section and provided with first attachment and sealing means for being sealingly attached to such first pipe section;
an input portion arranged at a second end of the outer mantle opposite the first end, adapted for being applied around a second pipe section, wherein the input portion comprises a skirt having a smaller diameter than the outer mantle and being arranged inside the outer mantle, with a bridge connecting the skirt to the outer mantle,
wherein the skirt has a free end directed away from the bridge to the output portion, with an annular accommodation slot being defined between the skirt, the outer mantle and the bridge;
a tightening assembly arranged inside the connection sleeve, the tightening assembly comprising:
an elastic annular clamp, adapted for being arranged tightly around the skirt, the annular clamp having a relaxed condition of relatively small diameter and a tense condition of relatively large diameter;
manipulation means adapted to keep the annular clamp in its tense condition arranged inside the annular accommodation slot around the skirt, and to release the annular clamp to make a transition to its relaxed condition to thus clamp around the skirt;
wherein the manipulation means are adapted to be manipulated by a manipulation tool that extends through the skirt during the manipulation, the manipulation resulting in the manipulation means releasing the annular clamp;
wherein
the manipulation means comprise:
a clamp carrier around which the annular clamp is carried in its tense condition;
a clamp shifter for shifting the annular clamp off the clamp carrier.

3. The connection assembly according to claim 1, wherein the internal diameter of the annular clamp in its relaxed condition is smaller than the outer diameter of the skirt.

4. The connection assembly according to claim 1, wherein the clamp carrier comprises a substantially cylindrical carrier body with an inner diameter substantially corresponding to the outer diameter of the skirt, and wherein the annular clamp in its tense condition is arranged around the carrier body.

5. The connection assembly according to claim 4, wherein the clamp shifter comprises a substantially cylindrical shifter body with an inner diameter substantially corresponding to the outer diameter of the carrier body.

6. The connection assembly according to claim 5, wherein the carrier body is arranged partially within the shifter body.

7. The connection assembly according to claim 5, wherein the carrier body and the shifter body are axially displaceable with respect to each other.

8. The connection assembly according to claim 5, wherein the shifter body is axially stationary within the connection sleeve and wherein the carrier body is axially displaceable with respect to the connection sleeve in a direction from the input portion to the output portion.

9. (canceled)

10. The connection assembly according to claim 8, wherein the manipulation of the manipulation means results in the carrier body being axially displaced with respect to the shifter body, with the shifter body remaining substantially in place.

11. The connection assembly according to claim 1, wherein the clamp carrier has an internal flange having an inner diameter smaller than the inner diameter of the skirt.

12. (canceled)

13. The connection assembly according to claim 1, wherein the connection sleeve has a bottom portion capable of supporting a flange of the clamp shifter.

14. The connection assembly according to claim 13, further comprising an external shifter support supporting the bottom portion of the connection sleeve.

15. The connection assembly according to claim 14, wherein the external shifter support comprises a support ring arranged under the bottom portion (16) of the connection sleeve, and a plurality of support arms having one end joining the support ring.

16. The connection assembly according to claim 15, wherein the support arms are relatively thin and bendable strips, and/or wherein the support arms extend axially along the outside of the connection sleeve and are longer than the connection sleeve.

17. The connection assembly according to claim 1, further comprising a removable stop device for preventing the clamp shifter shifting the annular clamp off the clamp carrier, wherein the stop device can be removed through the skirt.

18. The connection assembly according to claim 17, wherein the stop device comprises one or more stop members arranged between the clamp shifter and the clamp carrier to prevent the clamp carrier being shifted with respect to the clamp shifter.

19. The connection assembly according to claim 17, wherein the stop device comprises an axial stem having a free upper end, with a plurality of flexible arms having one end connected to the axial stem and carrying respective stop members at their free ends.

20. The connection assembly according to claim 1, further comprising protection means for protecting the connection assembly against high internal pressures.

21. The connection assembly according to claim 20, wherein the protection means comprise a second annular clamp arranged around an uppermost portion of the connection sleeve's mantle, aligned with the bridge, and a third annular clamp arranged around a lowermost portion of the connection sleeve's mantle.

22. The connection assembly according to claim 21, wherein the connection sleeve's mantle is provided with annular ridges for securing said second annular clamp and third annular clamp, respectively.

23. The connection assembly according to claim 20, wherein the protection means comprise a cylindrical mantle arranged around the entire connection sleeve's mantle.

24. The connection assembly according to claim 1, wherein the output portion comprises a substantially cylindrical sleeve portion, and wherein the attachment and sealing means comprise a first annular clamp arranged around said cylindrical sleeve portion;
wherein the output portion has an internal diameter smaller than the internal diameter of the outer mantle.

25. (canceled)

26. (canceled)
